(19) United States
(12) Patent Application Publication
(10) Pub. No.: US 2024/0393438 A1
(43) Pub. Date: Nov. 28, 2024

(54) HYBRID LiDAR SYSTEM

(71) Applicant: Neural Propulsion Systems, Inc., Pleasanton, CA (US)

(72) Inventors: Babak HASSIBI, San Marino, CA (US); Behrooz REZVANI, Petaluma, CA (US)

(73) Assignee: Neural Propulsion Systems, Inc., Pleasanton, CA (US)

(21) Appl. No.: 18/694,850

(22) PCT Filed: Oct. 6, 2022
(86) PCT No.: PCT/US2022/045849

§ 371 Date: Mar. 22, 2024

Related U.S. Application Data
(60) Provisional application No. 63/253,043, filed on Oct. 6, 2021.

(51) Int. Cl. G01S 7/481; G01S 7/484; G01S 7/4863; G01S 17/00; G01S 17/74; G01S 17/894; G01S 17/931

(52) U.S. Cl. CPC G01S 7/4815; G01S 7/4816; G01S 7/484; G01S 7/4863; G01S 17/006; G01S 17/74; G01S 17/894; G01S 17/931

(57) ABSTRACT

A hybrid LiDAR system may include a long-range LiDAR subsystem characterized by a first range and a first azimuth angular coverage, and a short-range LiDAR subsystem characterized by a second range and a second azimuth angular coverage, wherein the first range is greater than the second range, and the second azimuth angular coverage is greater than the first azimuth angular coverage.

### BACKGROUND

There is an ongoing demand for three-dimensional (3D) object tracking and object scanning for various applications, one of which is autonomous driving. The wavelengths of some types of signals, such as radar, are too long to provide the sub-millimeter resolution needed to detect smaller objects.

Light detection and ranging (LiDAR) systems use optical wavelengths that can provide finer resolution than other types of systems, thereby providing good range, accuracy, and resolution. In general, to determine the distances to objects, LiDAR systems illuminate a target area or scene with pulsed laser light and measure how long it takes for reflected pulses to be returned to a receiver.

One type of LiDAR system is referred to in the art as flash LiDAR. A flash LiDAR system operates similarly to a camera. In conventional flash LiDAR systems, a single, high-powered laser pulse illuminates a large field-of-view (FOV). An array of detectors (typically in close proximity to the laser) simultaneously detects light reflected by objects in the FOV. Typically, a lens focuses the reflected light onto the array of detectors. For each pulsed beam of light directed by the flash LiDAR system into the FOV, the detector array can receive reflected light corresponding to a frame of data. By using one or more frames of data, the ranges or distances of objects in the FOV can be obtained by determining the elapsed time between transmission of the pulsed beam of light by the laser and reception of the reflected light at the light detector array.

For some applications (e.g., autonomous driving), it may be challenging or impossible to design a flash LiDAR system that meets all of the cost, size, resolution, and power consumption requirements. Moreover, because of at least power limitations, the range of a conventional flash LiDAR system is generally limited to a couple hundred meters, which may be inadequate for some applications (e.g., autonomous driving).

### SUMMARY

This summary represents non-limiting embodiments of the disclosure.

In some aspects, the techniques described herein relate to a hybrid LiDAR system, including: a long-range LiDAR subsystem characterized by a first range and a first azimuth angular coverage; and a short-range LiDAR subsystem characterized by a second range and a second azimuth angular coverage, wherein: the first range is greater than the second range, and the second azimuth angular coverage is greater than the first azimuth angular coverage.

In some aspects, the techniques described herein relate to a hybrid LiDAR system, wherein the long-range LiDAR subsystem and the short-range LiDAR subsystem are configured to emit light simultaneously.

In some aspects, the techniques described herein relate to a hybrid LiDAR system, wherein the first range is at least 800 meters.

In some aspects, the techniques described herein relate to a hybrid LiDAR system, wherein the second range is less than or equal to 300 meters.

In some aspects, the techniques described herein relate to a hybrid LiDAR system, wherein the second azimuth angular coverage is at least 120 degrees.

In some aspects, the techniques described herein relate to a hybrid LiDAR system, wherein the first azimuth angular coverage is less than or equal to ten degrees.

In some aspects, the techniques described herein relate to a hybrid LiDAR system, wherein the long-range LiDAR subsystem is further characterized by a first elevation angular coverage, and the short-range LiDAR subsystem is further characterized by a second elevation angular coverage, wherein the second elevation angular coverage is larger than the first elevation angular coverage.

In some aspects, the techniques described herein relate to a hybrid LiDAR system, wherein the second elevation angular coverage is at least ten degrees.

In some aspects, the techniques described herein relate to a hybrid LiDAR system, wherein the first elevation angular coverage is less than or equal to five degrees.

In some aspects, the techniques described herein relate to a hybrid LiDAR system, wherein: the long-range LiDAR subsystem includes a first illuminator array, and a first detector array, and the short-range LiDAR subsystem includes a second illuminator array and a second detector array.

In some aspects, the techniques described herein relate to a hybrid LiDAR system, wherein the first illuminator array and the second illuminator array are configured to emit light simultaneously.

In some aspects, the techniques described herein relate to a hybrid LiDAR system, wherein a field-of-view (FOV) of the first illuminator array partially overlaps a FOV of the second illuminator array.

In some aspects, the techniques described herein relate to a hybrid LiDAR system, further including: at least one processor coupled to the first illuminator array, the second illuminator array, the first detector array, and the second detector array.

In some aspects, the techniques described herein relate to a hybrid LiDAR system, wherein the at least one processor is configured to: cause the first illuminator array and the second illuminator array to emit light simultaneously, obtain a first signal from the first detector array, obtain a second signal from the second detector array, and process the first signal and the second signal to estimate a position of at least one object in view of the hybrid LiDAR system.

In some aspects, the techniques described herein relate to a hybrid LiDAR system, wherein the first illuminator array includes a first illuminator and a second illuminator, wherein the first illuminator is configured to generate a first pulse sequence, and the second illuminator is configured to generate a second pulse sequence, wherein the first pulse sequence and the second pulse sequence are different.

In some aspects, the techniques described herein relate to a hybrid LiDAR system, wherein at least one of the long-range LiDAR subsystem or the short-range LiDAR subsystem includes: an illuminator array including one or more illuminators; and a detector array including one or more detectors.

In some aspects, the techniques described herein relate to a hybrid LiDAR system, wherein the one or more detectors include an avalanche photo-diode (APD), a single-photon avalanche diode (SPAD) detector, or a silicon photomultiplier (SiPM) detector.

In some aspects, the techniques described herein relate to a hybrid LiDAR system, wherein: the long-range LiDAR subsystem is configured to sense a first volume of space, and the short-range LiDAR subsystem is situated to sense a second volume of space.

In some aspects, the techniques described herein relate to a hybrid LiDAR system, wherein: the first volume of space and the second volume of space partially overlap.

In some aspects, the techniques described herein relate to a hybrid LiDAR system, wherein: the long-range LiDAR subsystem is further configured to create a first three-dimensional point cloud of the first volume of space, and the short-range LiDAR subsystem is further configured to create a second three-dimensional point cloud of the second volume of space.

In some aspects, the techniques described herein relate to a hybrid LiDAR system, further including: at least one processor configured to fuse the first three-dimensional point cloud and the second three-dimensional point cloud.

In some aspects, the techniques described herein relate to a hybrid LiDAR system, further including: at least one processor configured to apply optimal transport theory to fuse the first three-dimensional point cloud and the second three-dimensional point cloud.

In some aspects, the techniques described herein relate to a hybrid LiDAR system, wherein the long-range LiDAR system or the short-range LiDAR system includes at least one processor configured to fuse the first three-dimensional point cloud and the second three-dimensional point cloud.

In some aspects, the techniques described herein relate to a hybrid LiDAR system, wherein the long-range LiDAR system or the short-range LiDAR system includes at least one processor configured to apply optimal transport theory to fuse the first three-dimensional point cloud and the second three-dimensional point cloud.

In some aspects, the techniques described herein relate to a hybrid LiDAR system, wherein: the first volume of space and the second volume of space are non-intersecting.

In some aspects, the techniques described herein relate to a hybrid LiDAR system, wherein: the long-range LiDAR subsystem is further configured to create a first three-dimensional point cloud of the first volume of space, and the short-range LiDAR subsystem is further configured to create a second three-dimensional point cloud of the second volume of space.

In some aspects, the techniques described herein relate to a hybrid LiDAR system, wherein at least one of the long-range LiDAR subsystem or the short-range LiDAR subsystem includes: a plurality of N illuminators, each of the plurality of N illuminators configured to illuminate a respective one of a plurality of N illuminator fields-of-view (FOVs); a detector including at least one focusing component and at least one detector array, wherein the detector is configured to observe a detector FOV that overlaps at least a first illuminator FOV of the plurality ofN illuminator FOVs; and at least one processor configured to: cause a first illuminator of the plurality of N illuminators to emit an optical pulse to illuminate the first illuminator FOV, obtain a signal representing at least one reflected optical pulse detected by the detector, and determine a position of at least one target using the signal.

In some aspects, the techniques described herein relate to a hybrid LiDAR system, wherein the detector FOV is a first detector FOV, and wherein the detector is further configured to observe a second detector FOV that overlaps at least a second illuminator FOV of the plurality of N illuminator FOVs.

In some aspects, the techniques described herein relate to a hybrid LiDAR system, wherein the detector FOV overlaps a second illuminator FOV of the plurality of N illuminator FOVs.

In some aspects, the techniques described herein relate to a hybrid LiDAR system, wherein the at least one detector array includes a plurality of detector arrays, and wherein a particular focusing component of the at least one focusing component is configured to focus reflected signals on the plurality of detector arrays.

In some aspects, the techniques described herein relate to a hybrid LiDAR system, wherein the particular focusing component includes a lens and/or a mirror.

In some aspects, the techniques described herein relate to a hybrid LiDAR system, each of the plurality of N illuminators includes a respective laser.

In some aspects, the techniques described herein relate to a hybrid LiDAR system, wherein the at least one focusing component includes a plurality of focusing components, and the at least one detector array includes a plurality of detector arrays.

In some aspects, the techniques described herein relate to a hybrid LiDAR system, wherein the plurality of focusing components includes N focusing components and the plurality of detector arrays includes N detector arrays.

In some aspects, the techniques described herein relate to a hybrid LiDAR system, wherein each of the plurality of N illuminators is associated with a respective one of the N focusing components and a respective one of the N detector arrays.

In some aspects, the techniques described herein relate to a hybrid LiDAR system, wherein each of the N detector arrays includes at least 200 optical detectors.

In some aspects, the techniques described herein relate to a hybrid LiDAR system, wherein each of the at least 200 optical detectors includes an avalanche photodiode (APD), a single-photon avalanche diode (SPAD), or a silicon photomultiplier (SiPM).

In some aspects, the techniques described herein relate to a hybrid LiDAR system, wherein the at least one detector array includes a plurality of avalanche photodiodes, single-photon avalanche diode (SPAD) detectors, or silicon photomultiplier (SiPM) detectors.

In some aspects, the techniques described herein relate to a hybrid LiDAR system, wherein each of the plurality ofN illuminators includes a respective laser.

In some aspects, the techniques described herein relate to a hybrid LiDAR system, wherein the at least one focusing component includes a lens.

In some aspects, the techniques described herein relate to a hybrid LiDAR system, wherein the at least one detector array includes a plurality of detector arrays, and wherein the lens is shared by the plurality of detector arrays.

In some aspects, the techniques described herein relate to a hybrid LiDAR system, wherein each of the plurality of detector arrays includes at least 200 optical detectors.

In some aspects, the techniques described herein relate to a hybrid LiDAR system, wherein the at least one focusing component includes a mirror.

In some aspects, the techniques described herein relate to a hybrid LiDAR system, wherein each of the plurality of N illuminator FOVs is 1 degree or less in an azimuth direction and 1 degree or less in an elevation direction.

In some aspects, the techniques described herein relate to a hybrid LiDAR system, wherein the plurality of N illuminators includes at least 40 illuminators.

In some aspects, the techniques described herein relate to a hybrid LiDAR system, wherein the at least one detector array includes at least 200 optical detectors.

In some aspects, the techniques described herein relate to a hybrid LiDAR system, wherein the detector FOV is a first detector FOV and the optical pulse is a first optical pulse, and wherein the detector is further configured to observe a second detector FOV that overlaps a second illuminator FOV of the plurality of N illuminator FOVs, and wherein the at least one processor is further configured to cause a second illuminator of the plurality of N illuminators to emit a second optical pulse to illuminate the second illuminator FOV.

In some aspects, the techniques described herein relate to a vehicle including a hybrid LiDAR system, the hybrid LiDAR system including: a long-range LiDAR subsystem characterized by a first range and a first azimuth angular coverage; and a short-range LiDAR subsystem characterized by a second range and a second azimuth angular coverage, wherein: the first range is greater than the second range, and the second azimuth angular coverage is greater than the first azimuth angular coverage.

In some aspects, the techniques described herein relate to a vehicle, wherein: the long-range LiDAR subsystem includes a first portion situated to sense a first volume of space in front of the vehicle and a second portion situated to sense a second volume of space behind the vehicle, and the short-range LiDAR subsystem is situated to sense a third volume of space in front of the vehicle.

In some aspects, the techniques described herein relate to a vehicle, wherein: the first volume of space and the third volume of space partially overlap.

In some aspects, the techniques described herein relate to a vehicle, wherein: the first volume of space and the third volume of space are non-intersecting.

In some aspects, the techniques described herein relate to a vehicle, wherein the long-range LiDAR subsystem is further characterized by a first elevation angular coverage, and the short-range LiDAR subsystem is further characterized by a second elevation angular coverage, wherein the second elevation angular coverage is larger than the first elevation angular coverage.

In some aspects, the techniques described herein relate to a vehicle, wherein the first elevation angular coverage is less than or equal to five degrees, and the second elevation angular coverage is at least ten degrees.

In some aspects, the techniques described herein relate to a vehicle, wherein the first range is at least 800 meters, and the second range is less than or equal to 300 meters.

In some aspects, the techniques described herein relate to a vehicle, wherein the first azimuth angular coverage is less than or equal to ten degrees, and the second azimuth angular coverage is at least 120 degrees.

### BRIEF DESCRIPTION OF THE DRAWINGS

Objects, features, and advantages of the disclosure will be readily apparent from the following description of certain embodiments taken in conjunction with the accompanying drawings in which:

FIG. 1 illustrates components of a conventional flash LiDAR system.

FIG. 2 is an example illustration of a hybrid LiDAR system in accordance with some embodiments.

FIG. 3 is a block diagram of at least a portion of an example of a LiDAR subsystem in accordance with some embodiments.

FIG. 4 is a block diagram of an example hybrid LiDAR system in which the long-range LiDAR subsystem and the short-range LiDAR subsystem share some components in accordance with some embodiments.

FIGS. 5A, 5B, and 5C depict an exemplary illuminator in accordance with some embodiments.

FIGS. 6A, 6B, and 6C depict an exemplary detector in accordance with some embodiments.

FIG. 7 illustrates example components of a LiDAR subsystem in accordance with some embodiments.

FIG. 8 illustrates an exemplary detector array in accordance with some embodiments of the long-range LiDAR subsystem and/or the short-range LiDAR subsystem.

FIG. 9 is a diagram of certain components of a LiDAR subsystem for carrying out target identification and position estimation in accordance with some embodiments.

FIG. 10 illustrates portions of an exemplary LiDAR subsystem in accordance with some embodiments.

FIG. 11A illustrates portions of another exemplary LiDAR subsystem in accordance with some embodiments.

FIG. 11B illustrates how the illuminator of FIG. 11A can be implemented using multiple spatially-separated illuminators in accordance with some embodiments.

FIG. 12A is a diagram of an array of optical components of a LiDAR subsystem in accordance with some embodiments.

FIG. 12B is a diagram of the array of optical components of a LiDAR subsystem in accordance with some embodiments.

FIG. 13 is an illustration of the coverage provided by an example hybrid LiDAR system in accordance with some embodiments.

To facilitate understanding, identical reference numerals have been used, where possible, to designate identical elements that are common to the figures. It is contemplated that elements disclosed in one embodiment may be beneficially utilized in other embodiments without specific recitation. Moreover, the description of an element in the context of one drawing is applicable to other drawings illustrating that element.

### DETAILED DESCRIPTION

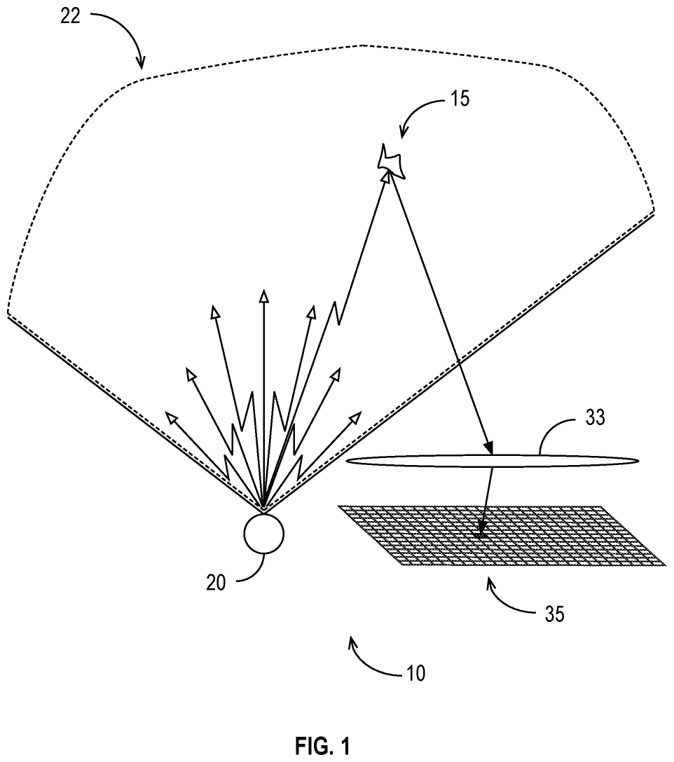

FIG. 1 illustrates components of a conventional flash LiDAR system 10. A single illuminator 20 (e.g., a laser) emits a pulsed beam of light that illuminates a large FOV 22. A target 15 in the FOV 22 reflects a pulse, which is focused by a lens 33 onto a detector array 35 comprising optical detectors (illustrated as squares in FIG. 1). Each of the optical detectors detects reflections from a particular direction (e.g., elevation and azimuth) to scan a large scene. Using the camera analogy, each of the optical detectors corresponds to a pixel of an image of the scene. The optical detectors in the detector array 35 can detect reflections of the pulses emitted by the illuminator 20, and they can measure the time of flight of each detected pulse and thereby determine the distances and angles of objects in the scene. Specifically, the angle of the target 15 can be determined from the identity of the optical detector(s) detecting reflections, and the distance between system 10 and the target 15 can be estimated as the speed of light multiplied by half of the time of flight of the pulse.

Conventional flash LiDAR systems suffer from a number of drawbacks, including a need for high power and expensive components. Because the FOV 22 is large, there is a trade-off between the power emitted by the illuminator 20 and the distance at which objects can be detected. For example, in order to illuminate an entire scene of interest and allow the detector array 35 to detect reflections off of objects at a reasonable distance from the flash LiDAR system 10, the illuminator 20 generally must emit high-power pulses so that enough energy reflected off of a target 15 reaches the detector array 35. Among other issues, these high-power pulses might not meet eye-safety standards. Furthermore, in order to provide high resolution, which is imperative for certain applications (e.g., autonomous driving), the quality of the lens 33 that focuses reflected pulses onto the detector array 35 must be high, which increases the cost of the lens 33. Additionally, the detector array 35 typically contains tens of thousands or, not uncommonly, hundreds of thousands of individual optical detectors, each for detecting a different, small portion of the scene, in order to unambiguously detect the angles of reflected pulses.

Disclosed herein are hybrid LiDAR systems that include a long-range LiDAR subsystem for detecting targets at longer distances and a short-range LiDAR subsystem for detecting targets at closer ranges. The hybrid LiDAR system includes a long-range LiDAR subsystem for detecting targets at longer ranges and a short-range LiDAR subsystem for detecting targets at closer ranges. In some example embodiments, distances of up to 300 meters can be measured with 15 cm accuracy by the short-range LiDAR subsystem. The hybrid LiDAR system combines the advantages of the short-range LiDAR subsystem, which can generate dense uniform point clouds of objects in near and short range, with the advantages of the long-range LiDAR subsystem, which can identify long-range point targets with high range resolution and high angular resolution.

Each of the long-range LiDAR subsystem and the short-range LiDAR subsystem can include a respective array of illuminators and a respective array of detectors, as described further below. Both the long-range LiDAR subsystem and the short-range LiDAR subsystem can be implemented with reasonable complexity and with eye-safe power levels.

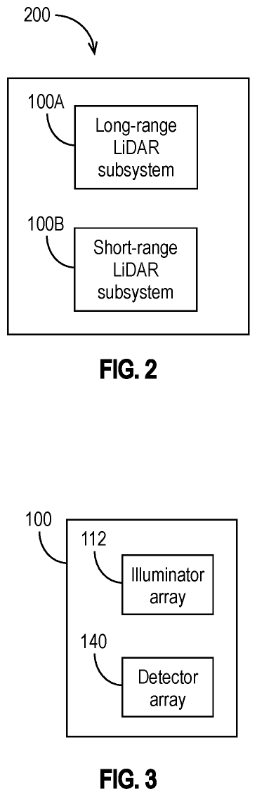

FIG. 2 is an example illustration of a hybrid LiDAR system 200 in accordance with some embodiments. The example hybrid LiDAR system 200 shown in FIG. 2 includes a long-range LiDAR subsystem 100A and a short-range LiDAR subsystem 100B, both of which are described in further detail below. The short-range LiDAR subsystem 100B and long-range LiDAR subsystem 100A may be discrete, separate subsystems, or they may have common components (e.g., a processor, optical components, etc.), as explained further below. References to the long-range LiDAR subsystem 100A and the short-range LiDAR subsystem 100B are for convenience and do not exclude the two subsystems having common or shared components (e.g., a processor, clock circuitry, control circuitry, etc.).

FIG. 3 is a high-level block diagram of at least a portion of an example of a LiDAR subsystem 100 in accordance with some embodiments. The LiDAR subsystem 100 shown in FIG. 3 can represent the long-range LiDAR subsystem 100A and/or the short-range LiDAR subsystem 100B shown in FIG. 2. As illustrated in FIG. 3, the LiDAR subsystem 100 example comprises an illuminator array 112 and a detector array 140. As described in further detail below, the illuminator array 112 comprises one or more illuminators 120 (e.g., lasers, other optical components). The detector array 140 comprises one or more detectors 130 (e.g., avalanche photo-diodes (APDs), single-photon avalanche diode (SPAD) detectors (e.g., solid-state detectors that can detect individual photons), silicon photomultiplier (SiPM) detectors (e.g., solid-state single-photon-sensitive devices based on single-photon avalanche diodes implemented on a common silicon substrate), etc.), also described in further detail below.

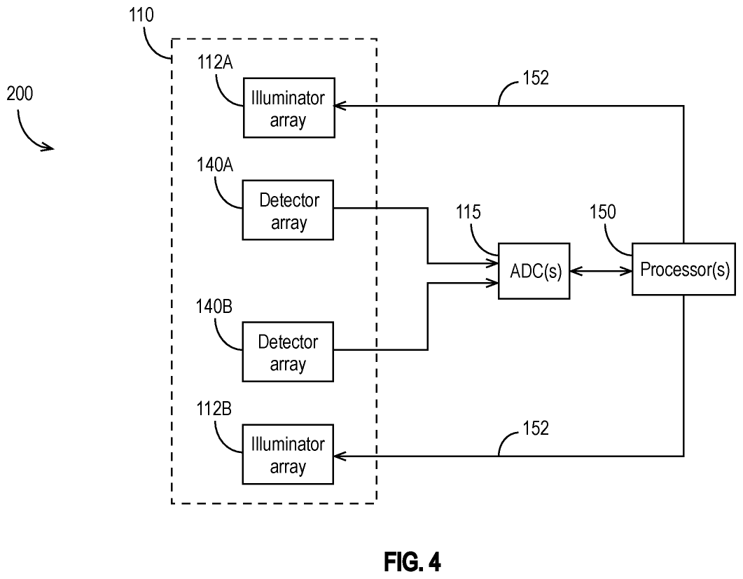

FIG. 4 is a block diagram of an example of a hybrid LiDAR system 200 in which the long-range LiDAR subsystem 100A and the short-range LiDAR subsystem 100B share some components in accordance with some embodiments. In the example of FIG. 4, the long-range LiDAR subsystem 100A comprises the illuminator array 112A and the detector array 140A, and the short-range LiDAR subsystem 100B comprises the illuminator array 112B and the detector array 140B.

The hybrid LiDAR system 200 example illustrated in FIG. 4 also includes at least one processor 150, which is coupled to the illuminator array 112A and the illuminator array 112B. The at least one processor 150 may be or comprise, for example, a digital signal processor, a microprocessor, a controller, an application-specific integrated circuit, or any other suitable hardware component (which may be suitable to provide and/or process analog and/or digital signals). The at least one processor 150 may provide control signals 152 to the array of optical components 110 (e.g., to the illuminator array 112A and the illuminator array 112B). The control signals 152 may, for example, cause one or more illuminators 120 in the array of optical components 110 to emit optical signals (e.g., light pulses, etc.) sequentially or simultaneously. The control signals 152 may cause the illuminators 120 to emit optical signals in the form of pulse sequences, which may be different for different illuminators 120.

The hybrid LiDAR system 200 may optionally also include one or more analog-to-digital converters (ADCs) 115 situated in the data path between the array of optical components 110 and the at least one processor 150. If present, the one or more ADCs 115 convert analog signals provided by detectors 130 in the detector array 140A and/or the detector array 140B to digital format for processing by the at least one processor 150. The analog signal provided by each of the detector array 140A and/or detector array 140B may be a superposition of reflected optical signals, which the at least one processor 150 may then process to determine (estimate) the positions of targets corresponding to (causing) the reflected optical signals.

It is to be understood that in addition to or instead of the ADC(s) 115 illustrated in FIG. 4, a hybrid LiDAR system 200 can include one or more time-to-digital converters (TDCs) (e.g., for use with SPAD, SiPM, or similar devices). As will be appreciated by those having ordinary skill in the art, a TDC may be a suitable approach to compute times of flight using SPAD, SiPM, and/or similar types of devices to detect reflected pulses.

It will be appreciated that there are myriad suitable hardware implementations of the hybrid LiDAR system 200 illustrated in FIG. 4. For example, the array of optical components 110 may be in the same physical housing (or enclosure) as the at least one processor 150 (and, if present, the one or more ADCs 115), or it may be physically separate. Similarly, the illuminator array 112A and illuminator array 112B can be in the same physical housing (or enclosure) as each other, or they may be separate. Likewise, the detector array 140A and detector array 140B can be in the same physical housing (or enclosure) as each other, or they may be separate. The illuminator array 112A, illuminator array 112B, detector array 140A, and/or detector array 140B can all be in the same physical housing (or enclosure) as each other, or they may be separate. Although the description herein refers to a single array of optical components 110 and generally distinguishes between the illuminator array 112A and detector array 140A of the long-range LiDAR subsystem 100A and the illuminator array 112B and detector array 140B of the short-range LiDAR subsystem 100B, it is to be understood that the illuminator array 112A, illuminator array 112B, detector array 140A, detector array 140B, and, generally speaking, the illuminators 120 and the detector(s) 130 can be situated within a hybrid LiDAR system 200 or a LiDAR subsystem 100 in any suitable physical arrangement (e.g., in multiple sub-arrays, etc.). The descriptions herein are for convenience.

### Illuminators

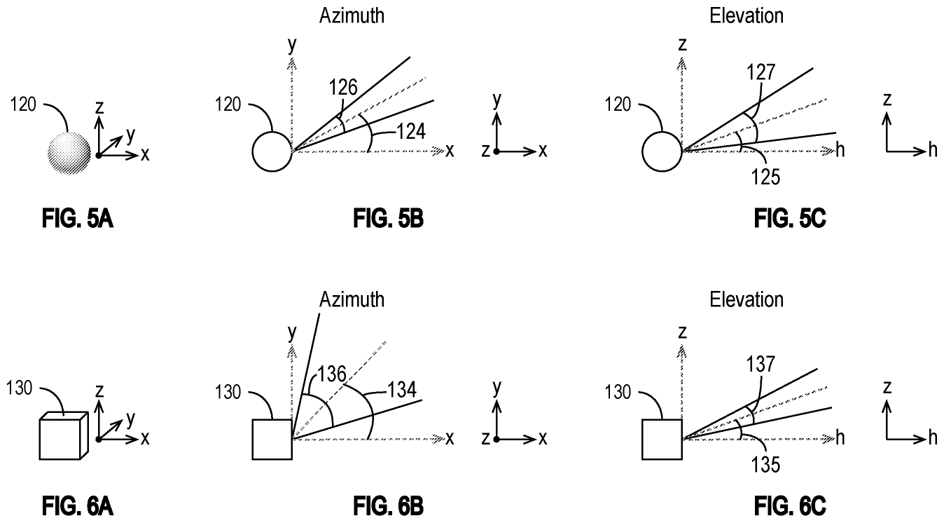

FIGS. 5A, 5B, and 5C depict an exemplary illuminator 120 in accordance with some embodiments. Each illuminator 120 of a hybrid LiDAR system 200 (e.g., of a LiDAR subsystem 100) has a position in three-dimensional space, which can be characterized in Cartesian coordinates (x, y, z) on x-, y-, and z-axes, as shown in FIG. 5A. Alternatively, any other coordinate system could be used (e.g., spherical). The illuminator 120 may be, for example, a laser operating at any suitable wavelength, for example, 905 nm or 1550 nm. The illuminator 120 is shown in FIG. 5A as having a spherical shape, which is merely symbolic. In an implementation, the illuminators 120 may be of any suitable size and shape. The illuminators 120 may be equipped with a lens (not shown) to focus and direct the emitted optical signals, as is known in the art. In addition, or alternatively, some or all of the illuminators 120 may also include one or more mirrors to direct the emitted optical signal in a specified direction. An illuminator 120 may also contain a diffuser to give its field of view a specified shape (square, rectangle, circle, ellipse, etc.) and to promote uniformity of the transmitted beam across its field of view.

As illustrated in FIG. 5B, in addition to having a position in three-dimensional space, each illuminator 120 has two azimuth angles: an azimuth boresight angle 124 and an azimuth field-of-view (FOV) angle 126. The azimuth angles (124, 126) are in a horizontal plane, which, using the coordinate system provided in FIG. 5A, is an x-y plane at some value of z. In other words, the azimuth boresight angle 124 and azimuth FOV angle 126 specify the “left-to-right” characteristics of optical signals emitted by the illuminator 120. The azimuth boresight angle 124 specifies the direction in which the illuminator 120 is pointed, which determines the general direction in which optical signals emitted by the illuminator 120 propagate. The azimuth FOV angle 126 specifies the angular width (e.g., beam width in the horizontal direction) of the portion of the scene illuminated by optical signals emitted by the illuminator 120.

As shown in FIG. 5C, each illuminator 120 also has two elevation angles: an elevation boresight angle 125 and an elevation FOV angle 127. The elevation angles are relative to a horizontal plane, which, using the coordinate system provided in FIG. 5A, is an x-y plane at some value of z. Accordingly, the horizontal axis shown in FIG. 5C is labeled “h” to indicate it is in some direction in an x-y plane that is not necessarily parallel to the x- or y-axis. (The direction of the “h” axis depends on the azimuth boresight angle 124.) The elevation boresight angle 125 and elevation FOV angle 127 specify the “up-and-down” characteristics of optical signals emitted by the illuminator 120. The elevation boresight angle 125 determines the height or attitude at which the illuminator 120 is pointed, which determines the general direction in which optical signals emitted by the illuminator 120 propagate. The elevation FOV angle 127 specifies the angular height (e.g., beam width in the vertical direction) of the portion of the scene illuminated by optical signals emitted by the illuminator 120.

The elevation FOV angle 127 of an illuminator 120 may be the same as or different from the azimuth FOV angle 126 of that illuminator 120. As will be understood by those having ordinary skill in the art, the beams emitted by illuminators 120 can have any suitable shape in three dimensions. For example, the emitted beams may be generally conical (where a cone is an object made up of a collection of (infinitely many) rays). The cross section of the cone can be any arbitrary shape, e.g., circular, ellipsoidal, square, rectangular, etc. In some embodiments, the cross section of the emitted beams are circular or square.

The volume of space illuminated by an illuminator 120 having boresight angles 124, 125 and FOV angles 126, 127 is referred to herein as the illuminator FOV 122. Objects that are within the illuminator FOV 122 of a particular illuminator 120 are illuminated by optical signals transmitted by that illuminator 120. The illuminator FOV 122 of an illuminator 120 is dependent on and determined by the position of the illuminator 120, and the boresight angles 124, 125 and FOV angles 126, 127 of the illuminator 120. The range of the illuminator 120 is dependent on its optical power and its vertical and horizontal FOV angles (e.g., intensity in watts per steradian). As explained further below, the long-range LiDAR subsystem 100A and the short-range LiDAR subsystem 100B use illuminators 120 having different characteristics (e.g., fields of view).

### Detectors

FIGS. 6A, 6B, and 6C depict an exemplary detector 130 in accordance with some embodiments. The detector 130 may comprise, for example, a photodetector array. In some embodiments, the detector 130 comprises an array of avalanche photodiodes. As will be appreciated by those having ordinary skill in the art, avalanche photodiodes operate under a high reverse-bias condition, which results in avalanche multiplication of the holes and electrons created by photon impact. As a photon enters the depletion region of the photodiode and creates an electron-hole pair, the created charge carriers are pulled away from each other by the electric field. Their velocity increases, and when they collide with the lattice, they create additional electron-hole pairs, which are then pulled away from each other, collide with the lattice, and create yet more electron-hole pairs, etc. The avalanche process increases the gain of the diode, which provides a higher sensitivity level than an ordinary diode.

In some embodiments, the detector 130 comprises a single-photon avalanche diode (SPAD) detector (e.g., a solid-state detector that can detect individual photons), a silicon photomultiplier (SiPM) detectors (e.g., solid-state single-photon-sensitive devices based on single-photon avalanche diodes implemented on a common silicon substrate), or another suitable detector.

Like the illuminator 120, the detector 130 may include a lens to focus the received signal, as discussed further below. In addition, or alternatively, like the illuminator 120, the detector 130 may include one or more mirrors to direct the received light in a selected direction.

The detector 130 is shown having a cuboid shape, which is merely symbolic. Each detector 130 has a position in three-dimensional space, which, as explained previously, can be characterized by Cartesian coordinates (x, y, z) on x-, y-, and z-axes, as shown in FIG. 6A. Alternatively, any other coordinate system could be used (e.g., spherical).

As illustrated in FIG. 6B, in addition to having a position in three-dimensional space, each detector 130 has two azimuth angles: an azimuth boresight angle 134 and an azimuth FOV angle 136. As is the case for the illuminators 120, the azimuth angles of the detectors 130 are in a horizontal plane, which, using the coordinate system provided in FIG. 6A, is an x-y plane at some value of z. In other words, the azimuth boresight angle 134 and azimuth FOV angle 136 specify the “left-to-right” positioning of the detector 130 (e.g., where in the horizontal plane it is “looking”). The azimuth boresight angle 134 specifies the direction in which the detector 130 is pointed, which determines the general direction in which it detects optical signals. The azimuth FOV angle 136 specifies the angular width in the horizontal direction of the portion of the scene sensed by the detector 130.

As shown in FIG. 6C, each detector 130 also has two elevation angles: an elevation boresight angle 135 and an elevation FOV angle 137. The elevation angles are relative to a horizontal plane, which, using the coordinate system provided in FIG. 6A, is an x-y plane at some value of z. Accordingly, the horizontal axis shown in FIG. 6C is labeled “h” to indicate it is in some direction in an x-y plane that is not necessarily parallel to the x- or y-axis. (The direction of the “h” axis depends on the azimuth boresight angle 134.) The elevation boresight angle 135 and elevation FOV angle 137 specify the “up-and-down” positioning of the detector 130. The elevation boresight angle 135 determines the height or altitude at which the detector 130 is directed, which determines the general direction in which it detects optical signals. The elevation FOV angle 137 specifies the angular height (e.g., beam width in the vertical direction) of the portion of the scene sensed by the detector 130. The elevation FOV angle 137 of a detector 130 may be the same as or different from the azimuth FOV angle 136 of that detector 130. In other words, the vertical span of the detector 130 may be the same as or different from its horizontal span.

The volume of space sensed by a detector 130 having boresight angles 134, 135 and FOV angles 136, 137 is referred to herein as a detector FOV 132. Optical signals reflected by objects within a particular detector 130's detector FOV 132 can be detected by that detector 130. The detector FOV 132 of a detector 130 is dependent on and determined by the position of the detector 130 within the hybrid LiDAR system 200 (e.g., it may be different for detector(s) 130 within the long-range LiDAR subsystem 100A as compared to detector(s) 130 within short-range LiDAR subsystem 100B), and the boresight angles 134, 135 and FOV angles 136, 137 of the detector 130. In some embodiments, the azimuth boresight angle 124, the azimuth FOV angle 126, the azimuth boresight angle 134, and the azimuth FOV angle 136 of a particular detector 130 are selected so that the detector FOV 132 largely coincides with the illuminator FOV 122 of a respective illuminator 120. The range of the detector 130 is dependent on the sensitivity of the detector 130 and irradiance on target.

### LiDAR Subsystems

The long-range LiDAR subsystem 100A and the short-range LiDAR subsystem 100B can be similar or identical in some respects. This section describes a LiDAR subsystem 100, which, unless otherwise indicated, can be the long-range LiDAR subsystem 100A and/or short-range LiDAR subsystem 100B.

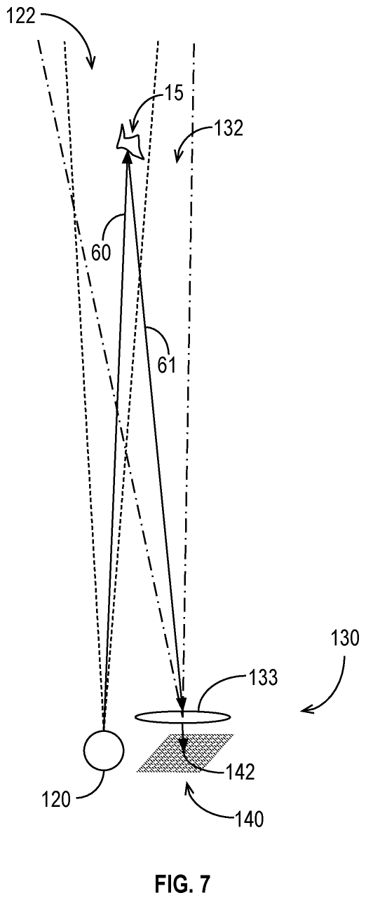

FIG. 7 illustrates example components of a LiDAR subsystem 100 (e.g., a long-range LiDAR subsystem 100A or a short-range LiDAR subsystem 100B) in accordance with some embodiments. An illuminator 120 (e.g., a laser) illuminates an illuminator FOV 122 (the extent of which is illustrated using dotted lines; as explained above, the illuminator FOV 122 is three-dimensional and is dependent on the azimuth FOV angle 126 and the elevation FOV angle 127). As described herein, each LiDAR subsystem 100 includes a plurality of illuminators 120, only one of which is illustrated in FIG. 7. Associated with the illuminator 120 is a detector 130, which, in the example of FIG. 7, comprises a lens 133 and a detector array 140. The detector 130 has a detector FOV 132 (the extent of which is illustrated using dash-dot lines; as explained above, the detector FOV 132 is three-dimensional and is dependent on the azimuth FOV angle 136 and the elevation FOV angle 137).

FIG. 7 shows only components of one detector 130. It is to be appreciated, as explained further below, that there are various ways the detector 130 can be implemented. For example, some or all of the detector 130 components can be physically separate from those of detector(s) 130 responsible for detecting reflected signals emitted by other illuminators 120 (e.g., each detector 130 has a dedicated lens 133 and a dedicated detector array 140). Alternatively, some or all of the detector 130 components can be shared by multiple illuminators 120. For example, the detector array 140 illustrated in FIG. 7 can be a portion of a larger, monolithic detector array. Similarly, the lens 133 can be a dedicated lens, or it can be shared by multiple detector arrays 140.

As shown in FIG. 7, the illuminator 120 emits an emitted pulse 60, which is reflected by a target 15 within the illuminator FOV 122. The reflected pulse 61 strikes the lens 133 of the detector 130, which focuses the reflected pulse 61 onto the detector array 140. The detector array 140 comprises optical detectors (e.g., as described above), each of which corresponds to a particular direction of the scene. In the illustrated example, the reflected pulse 61 is detected by an optical detector 142, shown as a filled square. The distance between the illuminator 120/detector 130 and the target 15 can be determined as the speed of light multiplied by half of the time from when the illuminator 120 emitted the emitted pulse 60 and when the detector 130 detected the reflected pulse 61. The angular position of the target 15 relative to the long-range LiDAR subsystem can be determined from the identity of the optical detector 142 in the detector array 140 that detected the reflected pulse 61.

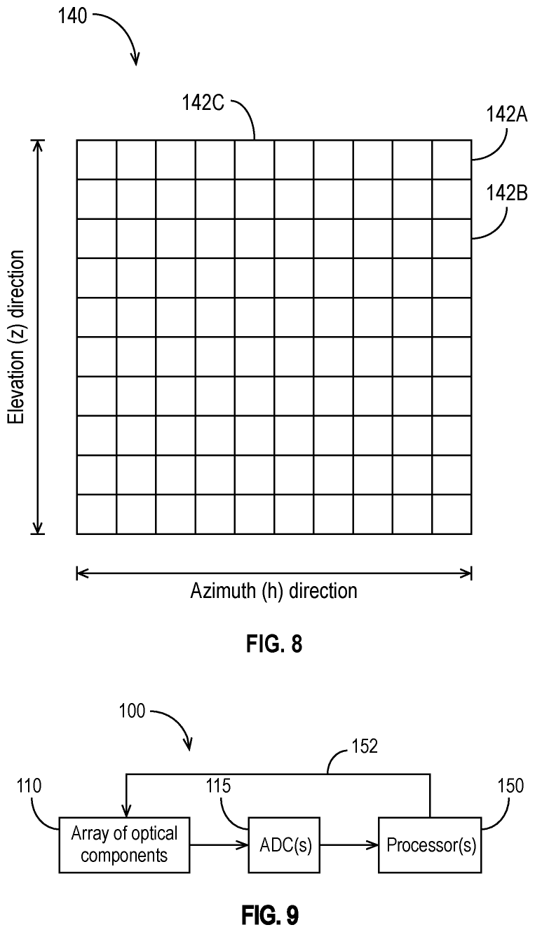

FIG. 8 illustrates an exemplary detector array 140 in accordance with some embodiments of the long-range LiDAR subsystem 100A and/or short-range LiDAR subsystem 100B. The illustrated detector array 140 comprises a plurality of optical detectors 142, with optical detectors 142A, 142B, and 142C labeled. The detector array 140 example of FIG. 8 is 10×10 in size and therefore has a total of 100 optical detectors 142, but it is to be appreciated that the detector array 140 can have any suitable number of optical detectors 142. Similarly, although the illustrated detector array 140 has the same number of rows (e.g., in the elevation (z) direction) and columns (e.g., in the azimuth (h) direction, which, as explained above, is somewhere in the x-y plane), it is to be appreciated that the detector array 140 need not be square in shape. For example, the detector array 140 could be rectangular (e.g., having more rows than columns or vice versa).

The detector array 140 shown in FIG. 8 can be implemented in many ways. For example, it may be implemented using a dedicated physical component having the desired number of optical detectors 142 (e.g., 100 detectors for the example shown in FIG. 8). Alternatively, the detector array 140 can be a distinct, non-overlapping region within a larger array of optical detectors (e.g., one physical array of optical detectors 142 can be logically partitioned into multiple, non-overlapping subsets, each of which operates as a separate detector array 140). It is to be appreciated that a physical array of optical detectors 142 can be used to implement the detector array 140A of the long-range LiDAR subsystem 100A and the detector array 140B of the short-range LiDAR subsystem 100B (e.g., individual optical detectors 142 can be assigned to one or the other of the long-range LiDAR subsystem 100A and the short-range LiDAR subsystem 100B).

FIG. 9 is a diagram of certain components of a LiDAR subsystem 100 (e.g., a long-range LiDAR subsystem 100A or a short-range LiDAR subsystem 100B) for carrying out target identification and position estimation in accordance with some embodiments. The LiDAR subsystem 100 includes an array of optical components 110 coupled to at least one processor 150. The at least one processor 150 may be, for example, a digital signal processor, a microprocessor, a controller, an application-specific integrated circuit, or any other suitable hardware component (which may be suitable to process analog and/or digital signals). The at least one processor 150 may provide control signals 152 to the array of optical components 110. The control signals 152 may, for example, cause one or more illuminators 120 in the array of optical components 110 to emit optical signals (e.g., light pulses, etc.) sequentially or simultaneously. The control signals 152 may cause the illuminators 120 to emit optical signals in the form of pulse sequences, which may be different for different illuminators 120.

The array of optical components 110 may be in the same physical housing (or enclosure) as the at least one processor 150, or it may be physically separate. Although the description herein refers to a single array of optical components 110, it is to be understood that the illuminators 120 and the detector(s) 130 can be situated within the LiDAR subsystem 100 in any suitable physical arrangement (e.g., in multiple sub-arrays, etc.).

The LiDAR subsystem 100 may optionally also include one or more analog-to-digital converters (ADCs) 115 disposed between the array of optical components 110 and the at least one processor 150. If present, the one or more ADCs 115 convert analog signals provided by detectors 130 in the array of optical components 110 to digital format for processing by the at least one processor 150. The analog signal provided by each of the detectors 130 may be a superposition of reflected optical signals (e.g., reflected pulses 61) detected by that detector 130, which the at least one processor 150 may then process to determine the positions of targets 15 corresponding to (causing) the reflected optical signals.

As explained above, it is to be understood that in addition to or instead of the ADC(s) 115 illustrated in FIG. 9, a LiDAR subsystem 100 can include one or more time-to-digital converters (TDCs) (e.g., for use with SPAD, SiPM, or similar devices). As will be appreciated by those having ordinary skill in the art, a TDC may be a suitable approach to compute times of flight using SPAD, SiPM, and/or similar types of devices to detect reflected pulses 61.

Although FIG. 9 illustrates a single LiDAR subsystem 100, it is to be appreciated that a hybrid LiDAR system 200 can include multiple instances of the components illustrated in FIG. 9. For example, a hybrid LiDAR system 200 can include one instance of the components shown in FIG. 9 for a long-range LiDAR subsystem 100A and a second instance of the components shown in FIG. 9 for a short-range LiDAR subsystem 100B. Alternatively, or in addition, the long-range LiDAR subsystem 100A and the short-range LiDAR subsystem 100B can share some components (e.g., at least one processor 150), as described above in the discussion of FIG. 4.

As described further below, in some embodiments, each illuminator 120 of a LiDAR subsystem 100 (e.g., the long-range LiDAR subsystem 100A or short-range LiDAR subsystem 100B) is associated with a respective detector array 140 that can be significantly smaller (e.g., have fewer optical detectors 130) than the massive detector array that is typically required in a conventional flash LiDAR system. In these embodiments, the number of detector arrays 140 is equal to the number of illuminators 120.

In other embodiments, a plurality of illuminators 120 with non-overlapping illuminator FOVs 122 can be fired (caused to emit signals) simultaneously. The corresponding detectors 130 assigned to each illuminator 120, whether portions of a single detector 130 or a respective plurality of detectors 130, will correspondingly have non-overlapping detector FOVs 132. Therefore, each portion of the detector array 140 is unambiguously associated with a respective one of the plurality of illuminators 120. This allows the LiDAR subsystem 100 to unambiguously detect the time-of-flight and angular position of a target even when illuminators 120 are fired simultaneously. The ability to fire a plurality of illuminators 120 (e.g., lasers) simultaneously allows one to scan the scenery in a more rapid fashion and yields a higher frame-per-second rate for the output of the LiDAR subsystem 100.

In some embodiments, a single detector array 140 is used to detect reflections of optical signals emitted by all of the illuminators 120 in the LiDAR subsystem 100.

The illuminators 120 in a LiDAR subsystem 100 may be identical to each other, or they may differ in one or more characteristics. For example, different illuminators 120 have different positions in the LiDAR subsystem 100 and therefore in space (i.e., they have different (x, y, z) coordinates). The boresight angles 124, 125 and FOV angles 126, 127 of different illuminators 120 may also be the same or different. For example, subsets of illuminators 120 may have configurations whereby they illuminate primarily targets within a certain range of the LiDAR subsystem 100 and are used in connection with detectors 130 that are configured primarily to detect targets within that same range. Similarly, the power of optical signals emitted by different illuminators 120 can be the same or different. For example, illuminators 120 intended to illuminate targets at very large distances from the long-range LiDAR subsystem 100A may use more power than illuminators 120 intended to illuminate targets at somewhat closer distances from the long-range LiDAR subsystem 100A and/or more power than illuminators 120 used in short-range LiDAR subsystem 100B.

The boresight angles 124, 125 and the FOV angles 126, 127 of the illuminators 120 can be selected so that the beams emitted by different illuminators 120 overlap, thereby resulting in different illuminators 120 illuminating overlapping portions of a scene. Unlike conventional LiDAR systems, embodiments of the hybrid LiDAR system 200 disclosed herein are able to resolve the three-dimensional positions of multiple targets within these overlapping regions of space. Moreover, they do not require any moving parts.

In some embodiments, multiple illuminators 120 emit optical signals simultaneously. If the illuminator FOVs 122 of the illuminators 120 that emit optical signals simultaneously are non-overlapping, there is no ambiguity in the times-of-flight of optical signals emitted by the illuminators 120, reflected by the target(s) 15, and detected by the detectors 130. The ability to fire (cause optical signals to be emitted by) multiple illuminators 120 at the same time can allow the LiDAR subsystem 100 to scan the scenery faster and thus increase the number frames per second (FPS) that the LiDAR subsystem 100 generates.

The detectors 130 of the LiDAR subsystem 100 may be identical to each other, or they may differ in one or more characteristics. For example, different detectors 130 have different positions in the LiDAR subsystem 100 and therefore in space (i.e., they have different (x, y, z) coordinates). The boresight angles 134, 135 and FOV angles 136, 137 of different detectors 130 may also be the same or different. For example, subsets of detectors 130 may have configurations whereby they observe targets within a certain range of the LiDAR subsystem 100 and are used in connection with illuminators 120 that are configured primarily to illuminate targets within that same range.

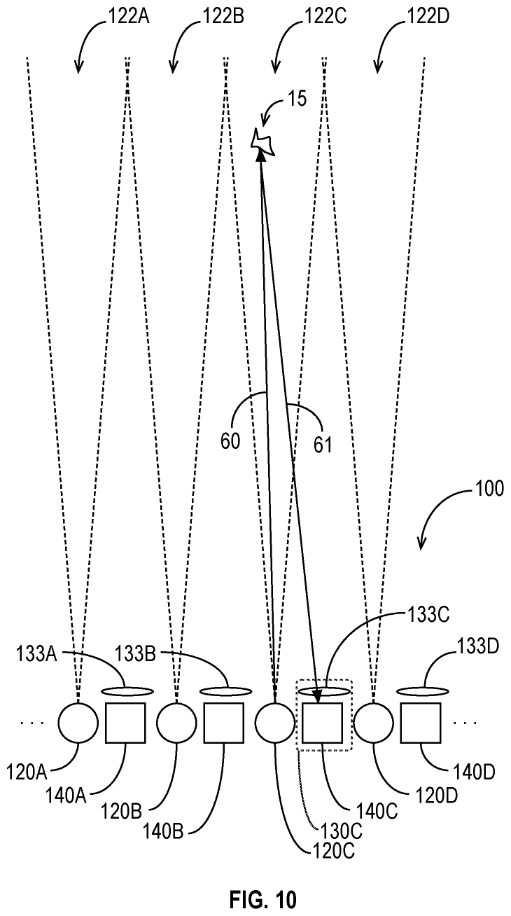

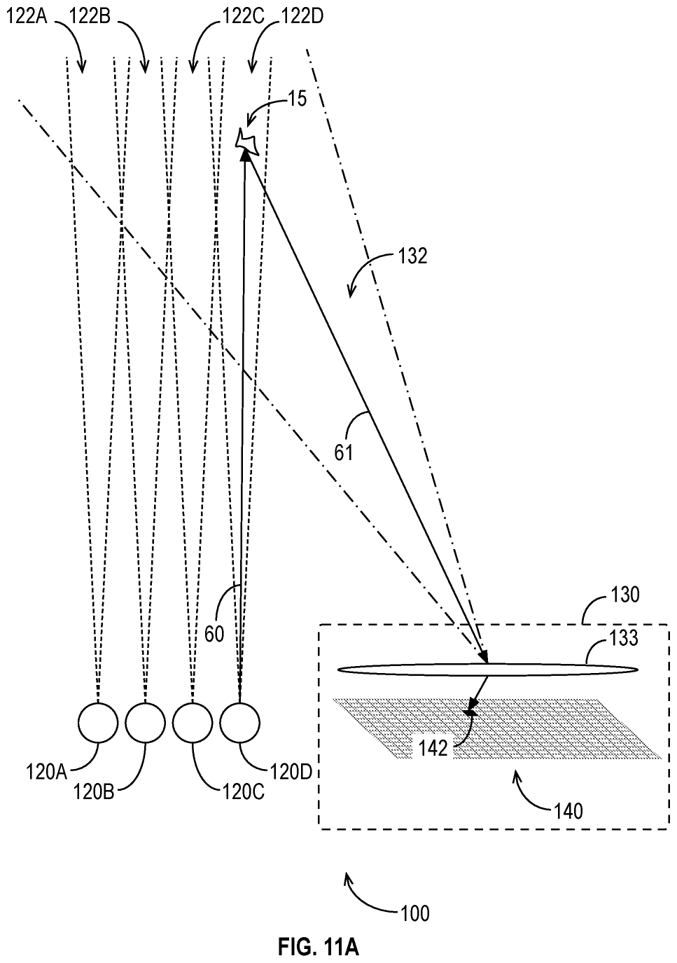

FIG. 10 illustrates portions of an example of a LiDAR subsystem 100 in accordance with some embodiments. The LiDAR subsystem 100 example includes a plurality of illuminators 120. FIG. 10 illustrates illuminators 120A, 120B, 120C, and 120D, which illuminate, respectively, illuminator FOVs 122A, 122B, 122C, and 122D. It is to be appreciated that the LiDAR subsystem 100 can include many more or fewer illuminators 120 than shown in FIG. 10.

The LiDAR subsystem 100 example of FIG. 10 also includes a plurality of detectors 130. To avoid obscuring the drawing, only the detector 130C is labeled in FIG. 10, and only the detectors 130 corresponding to the illustrated illuminators 120 are shown. Each of the example detectors 130 shown in the example comprises a lens 133 and a detector array 140. Specifically, the LiDAR subsystem 100 example shown in FIG. 10 includes lenses 133A, 133B, 133C, and 133D, and detector arrays 140A, 140B, 140C, and 140D. It is to be appreciated that the detectors 130 can include additional or alternative focusing components (e.g., mirrors, etc.), which may be shared or dedicated, as explained above. Each of the detectors 130 has a detector FOV 132 (not illustrated in FIG. 10 to avoid obscuring the drawing) that overlaps the respective illuminator FOV 122 at some distance (or range of distances). Thus, the illuminators 120 and detectors 130 in the example LiDAR subsystem 100 shown in FIG. 10 are in a one-to-one relationship. In other words, each illuminator 120 is assigned a respective detector 130.

In the example of FIG. 10, a target 15 is within the illuminator FOV 122C, and it is also within the respective detector FOV 132 of the detector 130C (not illustrated or labeled to avoid obscuring the drawing). As shown in FIG. 10, an emitted pulse 60 from the illuminator 120C is reflected by the target 15. The reflected pulse 61 is focused by the lens 133C onto the detector array 140C, where it is detected by at least one optical detector 142 (not shown in FIG. 10 due to scale) of the detector array 140C.

An example illustrates potential benefits of the disclosed LiDAR subsystem 100, such as the example embodiment shown in FIG. 10. Assume that the objective of a LiDAR subsystem 100 is to detect targets 15 that are primarily directly in front of it (e.g., for a system used in autonomous driving, cars that are ahead of the vehicle). Assume that together the illuminators 120 illuminate an azimuth FOV angle of 12 degrees and an elevation FOV angle of 4 degrees. If each of the illuminators 120 has an azimuth FOV angle 126 of 1 degree and an elevation FOV angle 127 of 1 degree, a total of 48 illuminators 120 can illuminate the desired volume of space. If the target resolution of the LiDAR subsystem 100 is 0.05 degrees in both the azimuth and elevation directions, the detector arrays 140 (whether implemented using separate physical components or as non-overlapping portions of a larger array of detectors) can be as small as 20×20 (400 optical detectors 142). The number of optical detectors 142 per illuminator 120 can be even smaller if the illuminator FOVs 122 are narrower.

The disclosed LiDAR subsystems 100 offer several advantages relative to conventional LiDAR systems (e.g., flash LiDAR systems). For example, because the illuminator FOVs 122 are narrow, pulses emitted by the illuminators 120 travel further without being dispersed as they would be if the illuminator FOVs 122 were wider. Thus, for a given power level, pulses originating from the illuminators 120 (emitted pulses 60) can reach and be reflected by objects (targets) at distances that are considerably larger than the maximum detectable-object distance of a conventional flash LiDAR system. Likewise, because the illuminator FOVs 122 are narrow, the reflected pulses 61 caused by emitted optical signals from individual illuminators 120 can reach and be detected by detectors 130 using a much smaller number of optical detectors 142, each of which “looks at” only a narrow detector FOV 132. The narrow detector FOV 132 of each detector 130 substantially coincides with the illuminator FOV 122 of the respective illuminator 120 (e.g., by collocating each illuminator 120 and its respective detector 130 and choosing suitable azimuth boresight angle 124, elevation boresight angle 125, azimuth FOV angle 126, elevation FOV angle 127, azimuth boresight angle 134, elevation boresight angle 135, azimuth FOV angle 136, and elevation FOV angle 137).

Additionally, a benefit of having multiple spatially-separated illuminators 120 is that the LiDAR subsystem 100 can reach (detect objects at) longer distances without violating eye safety restrictions. For example, if the beams of two illuminators 120 overlap at a particular point in the field (scene), a person situated at that location will see two separated beams from the illuminators 120, which will form two different spots on the person's retina. Laser eye-safety guidelines (e.g., ANSI Z13.1-2014 or similar) may treat this configuration as an extended source and may be less restrictive than if all the incident power at the person's eye were coming from a single illuminator 120.

Furthermore, the power levels of individual illuminators 120 can be dynamically adjusted to, for example, maintain the quality of reflected pulses 61 (and thereby avoid detector 130 saturation), and to meet eye safety standards while not affecting the overall long-range FOV of the LiDAR subsystem 100.

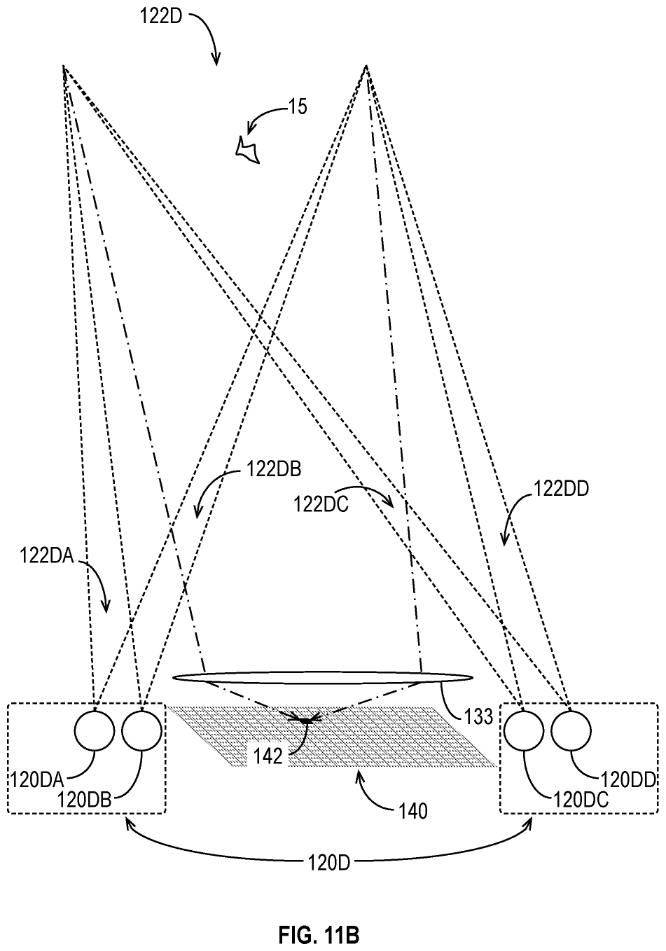

FIG. 11A illustrates portions of another example of a LiDAR subsystem 100 in accordance with some embodiments. The LiDAR subsystem 100 example of FIG. 11A includes a plurality of illuminators 120. FIG. 11A illustrates four illuminators 120A, 120B, 120C, and 120D, which illuminate, respectively, illuminator FOVs 122A, 122B, 122C, and 122D. It is to be appreciated that the LiDAR subsystem 100 can include many more or fewer than four illuminators 120.

The LiDAR subsystem 100 shown in FIG. 11A also includes a detector 130. The detector 130 has a detector FOV 132 that overlaps all of the illuminator FOVs 122A, 122B, 122C, and 122D at some distance (or range of distances). The detector 130 example shown in FIG. 11A includes at least one focusing component and at least one detector array 140 (e.g., comprising optical detectors 142). In the example of FIG. 11A, the at least one focusing component is shown as a single lens 133, and the at least one detector array is shown as a single detector array 140. In combination with the lens 133, each portion of the detector array 140 “looks at” a different region of the scene and therefore has a respective FOV. Distinct subsets of detectors in the detector array 140 can be considered to have distinct, non-overlapping fields-of-view. Thus, each optical detector 142 of the detector array 140 has a distinct detector FOV 132 that does not overlap the detector FOV 132 of any other optical detector 142. Thus, in combination with the at least one focusing component (e.g., lens 133), each optical detector 142 of the detector array 140 has, effectively, a narrow detector FOV 132 (determined by the resolution of the LiDAR subsystem 100) that allows it to detect only optical signals reflected by targets within its respective detector FOV 132.

As illustrated in the example of FIG. 11A, a target 15 is within the illuminator FOV 122D, and it is also within the overall detector FOV 132 of the detector 130. In operation, the illuminator 120D emits the emitted pulse 60, which is reflected by the target 15. The at least one focusing component (e.g., the lens 133 in FIG. 11A) focuses the reflected pulse 61 onto the optical detector 142 of the detector array 140, which is the portion of the detector array 140 that is “looking at” where the target 15 resides.

As explained above, a benefit of having multiple spatially-separated illuminators 120 is that the LiDAR subsystem 100 (whether the long-range LiDAR subsystem 100A or short-range LiDAR subsystem 100B) can reach longer distances without violating eye safety restrictions. For example, referring to FIG. 11A, the beams of illuminator 120C and illuminator 120D overlap just to the left of the illustrated target 15. If the target 15 were in this overlap region, it would receive twice as much irradiance than in its illustrated location, where it receives the irradiance of a single illuminator 120 (namely, illuminator 120D). The higher irradiance in the overlapping region due to a target 15 being illuminated by more than one illuminator 120 means that the target 15 can be seen at further distances from the LiDAR subsystem 100. Notably, if the same amount of irradiance were produced by a traditional flash LiDAR system, that system could violate eye safety standards. It will be appreciated by those having ordinary skill in the art in view of the disclosures herein that even if it might be difficult (e.g., because of timing issues) to accurately estimate the range of a very distant target 15 illuminated by multiple illuminators 120, being able to illuminate the target 15 by more than one illuminator 120 without violating eye safety standards could allow the LiDAR subsystem 100 to estimate at least the angular position of the target 15. In this way, at least the angular positions of very distant targets 15 can be estimated by the LiDAR subsystem 100, whereas these targets 15 likely could not be detected by conventional flash LiDAR systems due to eye safety standards.

In some embodiments, individual illuminators 120 in the LiDAR subsystem 100 comprise multiple spatially-separated illuminators 120 that illuminate overlapping illuminator FOVs 122. As an example, FIG. 11B illustrates how the illuminator 120D of FIG. 11A can be implemented using multiple spatially-separated illuminators 120. (The illuminator 120A, illuminator 120B, and illuminator 120C of FIG. 11A can be implemented similarly.) FIG. 11B shows four spatially-separated illuminators 120, namely the illuminator 120DA (with FOV 122DA), the illuminator 120DB (with FOV 122DB), the illuminator 120DC (with FOV 122DC), and the illuminator 120DD (with FOV 122DD), but it is to be appreciated that any number of illuminators 120 (i.e., more or fewer than four) could be used. In the example of FIG. 111B, the illuminator 120DA, the illuminator 120DB, the illuminator 120DC, and the illuminator 120DD are configured to illuminate near-complete overlapping FOVs at some distance. Each of the illuminator 120DA, the illuminator 120DB, the illuminator 120DC, and the illuminator 120DD can emit a respective emitted pulse 60 at the same time, or their emitted pulses 60 can be sequential, or, generally, emitted at different times. The reflected pulses 61 detected by the detector array 140 originating from the illuminator 120DA, the illuminator 120DB, the illuminator 120DC, and the illuminator 120DD can be combined (e.g., by a processor) using any suitable technique (e.g., by averaging). The at least one detector array 140 can be implemented in many ways. For example, it may be implemented using a single monolithic component, or it can be implemented using plurality of physical components (e.g., as a collection of separate monolithic components). Similarly, reflected optical signals (e.g., reflected pulse 61) can be focused by one or more optical components (e.g., lenses, mirrors, etc.), which may be dedicated to individual detector arrays 140 (however implemented) or shared by one or more detector arrays 140.

It is also to be appreciated that although the drawings herein show lenses 133 as the focusing components, the detectors 130 can include additional and/or alternative focusing components (e.g., mirrors, etc.), as explained above.

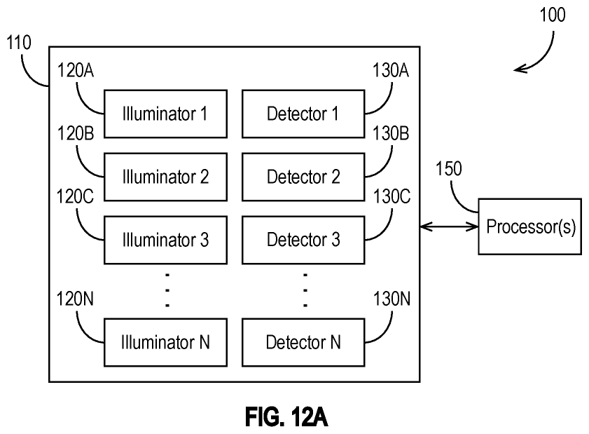

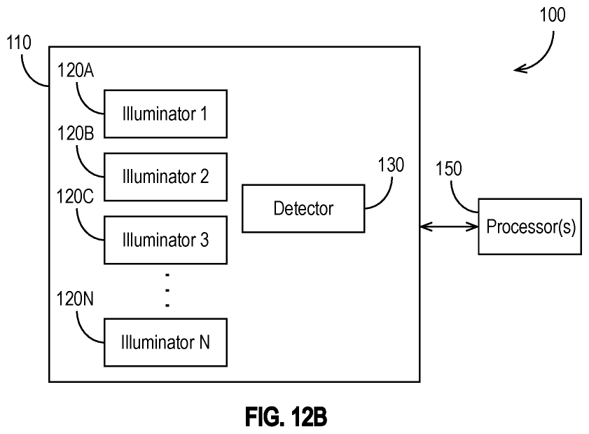

FIG. 12A is a diagram of the array of optical components 110 (shown in FIG. 9) of a LiDAR subsystem 100 in accordance with some embodiments (e.g., including the example embodiment illustrated in FIG. 10). As shown, the array of optical components 110 includes a plurality of illuminators 120 and a respective plurality of detectors 130. As described above (e.g., in the context of FIG. 10), each illuminator 120 is associated with a respective detector 130. Although FIG. 12A illustrates illuminators 120A, 120B, 120C, and 120N and detectors 130A, 130B, 130C, and 130N, thereby suggesting that there are fourteen illuminator 120/detector 130 pairs in the array of optical components 110, it is to be understood that, as used herein, the word “plurality” means “two or more.” Therefore, the array of optical components 110 may include as few as two illuminators 120 and two detectors 130, or it may include any number of illuminators 120 and a corresponding number of detectors 130 greater than two.

FIG. 12B is a diagram of the array of optical components 110 of a LiDAR subsystem 100 in accordance with some embodiments (e.g., including the example embodiment illustrated in FIG. 11A). As shown, the array of optical components 110 includes a plurality of illuminators 120 and a single detector 130. As described above (e.g., in the context of FIG. 11A), each illuminator 120 has a respective illuminator FOV 122, and the detector 130 has a FOV 132 that overlaps all of the illuminator FOVs 122 at some distance or range of distances. Although FIG. 12B illustrates illuminators 120A, 120B, 120C, and 120N, thereby suggesting that there are fourteen illuminators 120 in the array of optical components 110, it is to be understood that, as used herein, the word “plurality” means “two or more.” Therefore, the array of optical components 110 may include as few as two illuminators 120, or it may include any number of illuminators 120 greater than two.

### Long-Range LiDAR Subsystem

The long-range LiDAR subsystem 100A provides high target resolution over much larger distances than conventional LiDAR systems, and over larger distances than the short-range LiDAR subsystem 100B, which is described further below. The long-range LiDAR subsystem 100A includes a plurality of illuminators 120 (e.g., lasers) and a plurality of optical detectors 130 (e.g., photodetectors, such as avalanche photodiodes (APDs)). The individual illuminators 120 and detectors 130 can be, for example, as described above in the discussions of FIGS. 3 through 12B. The illuminators 120 and detectors 130 may be disposed in one or more arrays, which, in autonomous driving applications, may be mounted to the roof of a vehicle or in another location.

Rather than using a single, high-powered laser to illuminate the entire scene, the long-range LiDAR subsystem 100A uses an array of illuminators 120, each of which has an illuminator FOV 122 that is much narrower than that of the single laser used in conventional flash LiDAR systems. Together, the array of illuminators 120 can simultaneously illuminate the entire scene at distances that are considerably further away from the system than the maximum distance at which a conventional flash LiDAR system can detect objects. Furthermore, the long-range LiDAR subsystem 100A provides high resolution at distances much larger than those feasible for conventional flash LiDAR systems. Because the illuminator FOV 122 of each illuminator 120 is narrow, the power of each illuminator 120 can be lower than in a conventional LiDAR system, yet illuminate objects at larger distances from the long-range LiDAR subsystem 100A without violating eye-safety standards.

In some embodiments, the azimuth FOV angle 126 of the illuminator(s) 120 of the long-range LiDAR subsystem 100A is 1 degree or less. It is to be appreciated that, in general, there is no requirement for the azimuth FOV angle 126 to be any particular value.

In some embodiments, the elevation FOV angle 127 of the illuminator(s) 120 of the long-range LiDAR subsystem 100A is 1 degree or less. It is to be appreciated that, in general, there is no requirement for the elevation FOV angle 127 to be any particular value.

### Short-Range LiDAR Subsystem

The short-range LiDAR subsystem 100B provides high accuracy over shorter distances than covered by the long-range LiDAR subsystem 100A. For example, distances of up to 300 meters can be measured with 15 cm accuracy by the short-range LiDAR subsystem 100B.

In some embodiments, the short-range LiDAR subsystem 100B includes a plurality of illuminators 120 (e.g., lasers) and a plurality of optical detectors 130 (e.g., photodetectors, such as avalanche photodiodes (APDs)). The individual illuminators 120 and detectors 130 can be, for example, as described above in the discussions of FIGS. 3 through 12B. The illuminators 120 and detectors 130 may be disposed in one or more arrays, which, in autonomous driving applications, may be mounted to the roof of a vehicle or in another location.

In some embodiments, rather than using a single, high-powered laser to illuminate the entire scene, the short-range LiDAR subsystem 100B uses an array of illuminators 120, each of which has an illuminator FOV 122 that is much narrower than that of the single laser used in conventional flash LiDAR systems. Together, the array of illuminators 120 can simultaneously illuminate the entire scene at distances that are considerably further away from the system than the maximum distance at which a conventional flash LiDAR system can detect objects. Alternatively, the array of illuminators 120 can provide the same range as a conventional flash LiDAR system but by emitting less power. Because the illuminator FOV 122 of each illuminator 120 is narrow, the power of each illuminator 120 can be lower than in a conventional LiDAR system, yet illuminate objects at larger distances from short-range LiDAR subsystem 100B without violating eye-safety standards.

A conventional flash LiDAR could alternatively be used as a short-range LiDAR subsystem 100B.

A primary difference between the long-range LiDAR subsystem 100A and the short-range LiDAR subsystem 100B is that short-range LiDAR subsystem 100B has a wider FOV. For example, referring to FIGS. 5A through 5C and 6A through 6C, the azimuth FOV angles 126 and the elevation FOV angles 127 of the illuminators 120 in short-range LiDAR subsystem 100B can be significantly larger than the corresponding azimuth FOV angles 126 and elevation FOV angles 127 of the illuminators 120 in the long-range LiDAR subsystem 100A. Similarly, the azimuth FOV angle(s) 136, and/or the elevation FOV angle(s) 137 of the detector(s) 130 in short-range LiDAR subsystem 100B can be significantly larger than the corresponding elevation FOV angle(s) 137 and/or elevation FOV angle(s) 137 of the detector(s) 130 in the long-range LiDAR subsystem 100A.

For example, in some embodiments, the short-range LiDAR subsystem 100B has a large azimuth angular coverage (e.g., the azimuth FOV angle 126 can be 180° or 360°), some elevation angular coverage (e.g., the elevation FOV angle 127 can be 10° to 30°), and a range coverage up to some maximum range rₛₕₒᵣₜ (e.g., 150 m or more), where the azimuth angular coverage and elevation angular coverage are larger than those of the long-range LiDAR subsystem 100A, and the range is less than the maximum range of the long-range LiDAR subsystem 100A.

### Hybrid LiDAR System

As explained above, the hybrid LiDAR system 200 includes a long-range LiDAR subsystem 100A for detecting targets at longer ranges and a short-range LiDAR subsystem 100B for detecting targets at closer ranges. In some example embodiments, distances of up to 300 meters can be measured with 15 cm accuracy by the short-range LiDAR subsystem. The hybrid LiDAR system 200 combines the advantages of the short-range LiDAR subsystem 100B, which can generate dense uniform point clouds of objects in near and short range, with the advantages of the long-range LiDAR subsystem 100A, which can identify long-range point targets with high range resolution and high angular resolution.

The long-range LiDAR subsystem 100A and the short-range LiDAR subsystem 100B can operate simultaneously. In some embodiments, the illuminators 120 of the long-range LiDAR subsystem 100A emit light using pulse sequences that are different from the pulse sequences emitted by the illuminators 120 of the short-range LiDAR subsystem 100B.

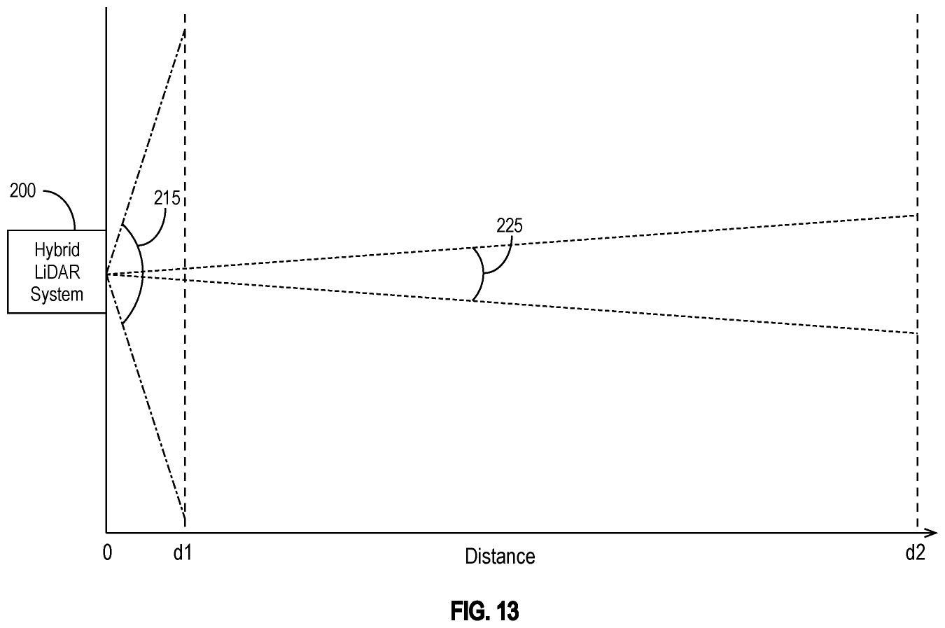

FIG. 13 is an illustration of coverage (e.g., overall azimuth and/or elevation FOV) of an example hybrid LiDAR system 200 in accordance with some embodiments. The short-range LiDAR subsystem 100B (not specifically illustrated in FIG. 13 but included in the hybrid LiDAR system 200 as described above) has a coverage 215 (which may be in a plane or in three-dimensional space), and the long-range LiDAR subsystem 100A (also not specifically illustrated in FIG. 13 but included in the hybrid LiDAR system 200 as described above) has a coverage 225 (which may be in a plane or in three-dimensional space). As shown in FIG. 13, the coverage 215 of the short-range LiDAR subsystem 100B is wider than the coverage 225 of the long-range LiDAR subsystem 100A but provides visibility to a shorter distance (labeled as d1 in FIG. 13, equivalent to rₛₕₒᵣₜ), whereas the coverage 225 is narrower and provides visibility to a longer distance (labeled as d2 in FIG. 13, equivalent to r_{long}) than the short-range LiDAR subsystem 100B. As explained above, the distance d1 may be, for example, up to 300 m, and the distance d2 may be significantly larger (e.g., 800 m or more).

The long-range LiDAR subsystem 100A has an azimuth angular coverage that is focused on a particular area of interest. For autonomous driving applications, the long-range LiDAR subsystem 100A is typically focused on the front and/or back of the vehicle, though other areas of focus (e.g., on the sides) are also possible.

The azimuth angular coverage of the long-range LiDAR subsystem 100A can be much smaller than that of the short-range LiDAR subsystem 100B (e.g., 20° to 30°). The elevation angular coverage could be, for example, only a few degrees because the long-range LiDAR subsystem 100A is focused on distances far away.

The long-range LiDAR subsystem 100A has a range, r_{long} (shown as d2), that is much longer than the range rₛₕₒᵣₜ (shown as d1), e.g., typically somewhere between 400 m and 800 m, though it could be longer or shorter.

In areas (e.g., at distances, ranges of distances, or volumes of space) where the coverage of the short-range LiDAR subsystem 100B does not overlap the coverage of the long-range LiDAR subsystem 100A, each subsystem can create its own three-dimensional (3D) point cloud of the scenery. As will be appreciated by those having ordinary skill in the art, a point cloud is a collection of points that represent a 3D shape or object/target. Each point cloud is a collection of points that represent a three-dimensional shape or feature, from which range, angle, and velocity information can be determined) that can be processed by a perception engine (e.g., the at least one processor 150). The point cloud from the long-range LiDAR subsystem 100A maps part of the scene, and the point cloud from short-range LiDAR subsystem 100B maps a non-intersecting part of the scene.

In areas (e.g., at distances, ranges of distances, or volumes of space) where the coverage 215 of the short-range LiDAR subsystem 100B and the coverage 225 of the long-range LiDAR subsystem 100A overlap (e.g., areas within the azimuth and elevation fields of view of the long-range LiDAR subsystem 100A that are within the range rₛₕₒᵣₜ), the short-range LiDAR subsystem 100B and the long-range LiDAR subsystem 100A can cooperate (e.g., directly or via a processor (e.g., the at least one processor 150) or other subsystem of the hybrid LiDAR system 200 that is coupled to short-range LiDAR subsystem 100B and long-range LiDAR subsystem 100A) and fuse their 3D point clouds to yield one or more composite 3D point clouds for the overlap area. In other words, the point cloud from the long-range LiDAR subsystem 100A can be combined with the point cloud from short-range LiDAR subsystem 100B to improve accuracy of target detection within the region that both the long-range LiDAR subsystem 100A and the short-range LiDAR subsystem 100B can observe.

Various methods can be used to fuse the 3D point clouds obtained from short-range LiDAR subsystem 100B and long-range LiDAR subsystem 100A in the common overlap area. These include Bayesian methods, SNR-based selection methods, and others. One way to fuse the 3D point clouds obtained from the long-range LiDAR subsystem 100A and the short-range LiDAR subsystem 100B is using optimal transport theory. As will be appreciated, it is useful to identify a measure of “distance” between pairs of probability distributions, and optimal transport theory can be used to construct a notion of distance between probability distributions. Stated another way, optimal transport theory provides a framework that explicitly accounts for geometric relationships by modeling a signal as mass that incurs a cost to move around its support.

As an example, a 3D point cloud from the long-range LiDAR subsystem 100A can be fused with a 3D point cloud of an overlapping region from short-range LiDAR subsystem 100B by, for example, pointwise multiplication of the individual point clouds from the different bands to obtain a fused point cloud. As more observations are gathered over time, the fused point cloud evolves and becomes more accurate. As a result, ghost targets can be eliminated (e.g., by eliminating candidate positions that are below a threshold probability), and the true positions of targets can be determined.

Accordingly, in some embodiments, a hybrid LiDAR system 200 comprises a long-range LiDAR subsystem 100A characterized by a first range (e.g., 800 meters or more) and a first azimuth angular coverage (e.g., less than or equal to 10 degrees) and a short-range LiDAR subsystem 100B characterized by a second range (e.g., less than or equal to 300 meters) and a second azimuth angular coverage (e.g., at least 120 degrees), where the first range is greater than the second range, and the second azimuth angular coverage is greater than the first azimuth angular coverage. As explained above, in some embodiments, the long-range LiDAR subsystem 100A and the short-range LiDAR subsystem 100B configured to emit light simultaneously. The long-range LiDAR subsystem 100A and the short-range LiDAR subsystem 100B may use distinct pulse sequences to allow a determination of which LiDAR subsystem 100 emitted the pulse sequence that resulted in a particular reflected signal.

In some embodiments, the long-range LiDAR subsystem 100A is further characterized by a first elevation angular coverage, and the short-range LiDAR subsystem 100B is further characterized by a second elevation angular coverage that is larger than the first elevation angular coverage. For example, the first elevation angular coverage may be less than or equal to 5 degrees, and the second elevation angular coverage may be at least 10 degrees.

In some embodiments, the long-range LiDAR subsystem 100A comprises an illuminator array 112A and a detector array 140A, and the short-range LiDAR subsystem 100B comprises a illuminator array 112B and a detector array 140B. The illuminator array 112A and the illuminator array 112B may be configured to emit light simultaneously (e.g., as directed by at least one processor 150). In some embodiments, a FOV of the long-range LiDAR subsystem 100A partially overlaps a FOV of the short-range LiDAR subsystem 100B. For example, any illuminator FOV 122 resulting from the azimuth boresight angle 124, elevation boresight angle 125, azimuth FOV angle 126, and/or elevation FOV angle 127 of the long-range LiDAR subsystem 100A can partially overlap an illuminator FOV 122 resulting from the azimuth boresight angle 124, elevation boresight angle 125, azimuth FOV angle 126, and/or elevation FOV angle 127 of the short-range LiDAR subsystem 100B. Alternatively, or in addition, any detector FOV 132 resulting from the azimuth boresight angle 134, elevation boresight angle 135, azimuth FOV angle 136, and/or elevation FOV angle 137 of the long-range LiDAR subsystem 100A can partially overlap a detector FOV 132 resulting from the azimuth boresight angle 134, elevation boresight angle 135, azimuth FOV angle 136, and/or elevation FOV angle 137 of the short-range LiDAR subsystem 100B.

In some embodiments, the hybrid LiDAR system 200 also includes at least one processor 150 coupled to the illuminator array 112A, the illuminator array 112B, the detector array 140A, and the detector array 140B. In some such embodiments, the at least one processor 150 is configured to cause the first illuminator array and the second illuminator array to emit light simultaneously and to obtain a first signal from the first detector array, obtain a second signal from the second detector array, and process the first signal and the second signal to estimate a position of at least one object (e.g., at least one target 15) in view of the hybrid LiDAR system 200.

In some embodiments, the hybrid LiDAR system 200 comprises an illuminator 120A and an illuminator 120B. In some embodiments, the illuminator 120A is configured to generate a first pulse sequence, and the illuminator 120B is configured to generate a second pulse sequence that is different from the first pulse sequence.

In some embodiments, the long-range LiDAR subsystem 100A and/or the short-range LiDAR subsystem 100B includes an illuminator array 112 comprising one or more illuminators 120 (e.g., lasers), and a detector array 140 comprising one or more detectors 130 (e.g., an avalanche photo-diode (APD), a single-photon avalanche diode (SPAD) detector, or a silicon photomultiplier (SiPM) detector).

In some embodiments, the long-range LiDAR subsystem 100A is configured to sense a first volume of space, and the short-range LiDAR subsystem 100B is configured to sense a second volume of space. The volumes of space sensed by the long-range LiDAR subsystem 100A and the short-range LiDAR subsystem 100B may partially overlap (e.g., as shown in FIG. 13), or they may be non-overlapping (non-intersecting).

In some embodiments, the long-range LiDAR subsystem 100A is configured to create a first three-dimensional (3D) point cloud representing the first volume of space, and the short-range LiDAR subsystem 100B is configured to create a second 3D point cloud representing the second volume of space. In some embodiments, the hybrid LiDAR system 200 includes at least one processor 150 configured to fuse the first and second 3D point clouds (e.g., to eliminate ghost targets and improve accuracy of target detection). In some embodiments, the long-range LiDAR subsystem 100A and/or the short-range LiDAR subsystem 100B includes at least one processor 150 configured to fuse the first and second 3D point clouds. The fusing process may take advantage of optimal transport theory.

As explained above, a vehicle can include a hybrid LiDAR system 200 as described herein. In some embodiments, the long-range LiDAR subsystem 100A comprises a first portion situated to sense a first volume of space in front of the vehicle and a second portion situated to sense a second volume of space behind the vehicle, and the short-range LiDAR subsystem 100B is situated to sense a third volume of space in front of the vehicle. In some embodiments, the first volume of space and the third volume of space partially overlap. In some embodiments, the first volume of space and the third volume of space are non-intersecting (non-overlapping). In some embodiments, the long-range LiDAR subsystem 100A is further characterized by a first elevation angular coverage (e.g., less than or equal to 5 degrees), and short-range LiDAR subsystem 100B is further characterized by a second elevation angular coverage that is larger than the first elevation angular coverage (e.g., at least 10 degrees). In some embodiments, the long-range LiDAR subsystem 100A is able to detect targets at a range of at least 800 meters, and the short-range LiDAR subsystem 100B is able to detect targets at a range up to about 300 meters. In some embodiments, the long-range LiDAR subsystem 100A has an azimuth angular coverage that is less than or equal to about 10 degrees, and the short-range LiDAR subsystem 100B has an azimuth angular coverage that is at least 120 degrees.

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used in the specification and the appended claims, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

As used in the specification and the appended claims, phrases of the form “at least one of A, B, and C,” “at least one of A, B, or C,” “one or more of A, B, or C,” and “one or more of A, B, and C” are interchangeable, and each encompasses all of the following meanings: “A only,” “B only,” “C only,” “A and B but not C,” “A and C but not B,” “B and C but not A,” and “all of A, B, and C.”

To the extent that the terms “include(s),” “having,” “has,” “with,” and variants thereof are used in the detailed description or the claims, such terms are intended to be inclusive in a manner similar to the term “comprising,” i.e., meaning “including but not limited to.”

The terms “exemplary” and “embodiment” are used to express examples, not preferences or requirements.

The term “coupled” is used herein to express a direct connection/attachment as well as a connection/attachment through one or more intervening elements or structures.

The terms “over,” “under,” “between,” and “on” are used herein refer to a relative position of one feature with respect to other features. For example, one feature disposed “over” or “under” another feature may be directly in contact with the other feature or may have intervening material. Moreover, one feature disposed “between” two features may be directly in contact with the two features or may have one or more intervening features or materials. In contrast, a first feature “on” a second feature is in contact with that second feature.

The term “substantially” is used to describe a structure, configuration, dimension, etc. that is largely or nearly as stated, but, due to manufacturing tolerances and the like, may in practice result in a situation in which the structure, configuration, dimension, etc. is not always or necessarily precisely as stated. For example, describing two lengths as “substantially equal” means that the two lengths are the same for all practical purposes, but they may not (and need not) be precisely equal at sufficiently small scales. As another example, a structure that is “substantially vertical” would be considered to be vertical for all practical purposes, even if it is not precisely at 90 degrees relative to horizontal.

The drawings are not necessarily to scale, and the dimensions, shapes, and sizes of the features may differ substantially from how they are depicted in the drawings.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

Furthermore, certain values are provided herein as examples (e.g., of ranges, angular coverage, accuracy, etc.), but these values are not intended to limit the scope of the disclosure. It will be appreciated by those having ordinary skill in the art that other values may be possible/achievable today, and that certain values may improve (e.g., accuracy, range, angular coverage, etc.) as the technology used to implement hybrid LiDAR systems 200 improves.

1. A hybrid LiDAR system, comprising:
a long-range LiDAR subsystem characterized by a first range and a first azimuth angular coverage; and
a short-range LiDAR subsystem characterized by a second range and a second azimuth angular coverage,
wherein:
the first range is greater than the second range, and
the second azimuth angular coverage is greater than the first azimuth angular coverage.

2. The hybrid LiDAR system recited in claim 1, wherein the long-range LiDAR subsystem and the short-range LiDAR subsystem are configured to emit light simultaneously.

3-6. (canceled)

7. The hybrid LiDAR system recited in claim 1, wherein the long-range LiDAR subsystem is further characterized by a first elevation angular coverage, and the short-range LiDAR subsystem is further characterized by a second elevation angular coverage, wherein the second elevation angular coverage is larger than the first elevation angular coverage.

8-9. (canceled)

10. The hybrid LiDAR system recited in claim 1, wherein:
the long-range LiDAR subsystem comprises a first illuminator array, and a first detector array, and
the short-range LiDAR subsystem comprises a second illuminator array and a second detector array.

11. The hybrid LiDAR system recited in claim 10, wherein the first illuminator array and the second illuminator array are configured to emit light simultaneously, and wherein a field-of-view (FOV) of the first illuminator array at least partially overlaps a FOV of the second illuminator array.

12. (canceled)

13. The hybrid LiDAR system recited in claim 10, further comprising:
at least one processor coupled to the first illuminator array, the second illuminator array, the first detector array, and the second detector array.

14. The hybrid LiDAR system recited in claim 13, wherein the at least one processor is configured to:
cause the first illuminator array and the second illuminator array to emit light simultaneously,
obtain a first signal from the first detector array,
obtain a second signal from the second detector array, and
process the first signal and the second signal to estimate a position of at least one object in view of the hybrid LiDAR system.

15. The hybrid LiDAR system recited in claim 10, wherein the first illuminator array comprises a first illuminator and a second illuminator, wherein the first illuminator is configured to generate a first pulse sequence, and the second illuminator is configured to generate a second pulse sequence, wherein the first pulse sequence and the second pulse sequence are different.

16. The hybrid LiDAR system recited in claim 1, wherein at least one of the long-range LiDAR subsystem or the short-range LiDAR subsystem comprises:
an illuminator array comprising one or more illuminators; and
a detector array comprising one or more detectors.

17. The hybrid LiDAR system recited in claim 16, wherein the one or more detectors comprise an avalanche photo-diode (APD), a single-photon avalanche diode (SPAD) detector, or a silicon photomultiplier (SiPM) detector.

18. The hybrid LiDAR system recited in claim 1, wherein:
the long-range LiDAR subsystem is configured to sense a first volume of space, and
the short-range LiDAR subsystem is situated to sense a second volume of space.

19. The hybrid LiDAR system recited in claim 18, wherein:
the first volume of space and the second volume of space partially overlap.

20. The hybrid LiDAR system recited in claim 19, wherein:
the long-range LiDAR subsystem is further configured to create a first three-dimensional point cloud of the first volume of space, and
the short-range LiDAR subsystem is further configured to create a second three-dimensional point cloud of the second volume of space.

21. The hybrid LiDAR system recited in claim 20, further comprising:
at least one processor configured to fuse the first three-dimensional point cloud and the second three-dimensional point cloud.

22. The hybrid LiDAR system recited in claim 20, further comprising:
at least one processor configured to apply optimal transport theory to fuse the first three-dimensional point cloud and the second three-dimensional point cloud.

23. The hybrid LiDAR system recited in claim 20, wherein the long-range LiDAR subsystem or the short-range LiDAR subsystem comprises at least one processor configured to fuse the first three-dimensional point cloud and the second three-dimensional point cloud.

24. The hybrid LiDAR system recited in claim 20, wherein the long-range LiDAR subsystem or the short-range LiDAR subsystem comprises at least one processor configured to apply optimal transport theory to fuse the first three-dimensional point cloud and the second three-dimensional point cloud.

25. The hybrid LiDAR system recited in claim 18, wherein:
the first volume of space and the second volume of space are non-intersecting.

26. The hybrid LiDAR system recited in claim 25, wherein:
the long-range LiDAR subsystem is further configured to create a first three-dimensional point cloud of the first volume of space, and
the short-range LiDAR subsystem is further configured to create a second three-dimensional point cloud of the second volume of space.

27. The hybrid LiDAR system recited in claim 1, wherein at least one of the long-range LiDAR subsystem or the short-range LiDAR subsystem comprises:
a plurality of N illuminators, each of the plurality of N illuminators configured to illuminate a respective one of a plurality of N illuminator fields-of-view (FOVs);
a detector comprising at least one focusing component and at least one detector array, wherein the detector is configured to observe a detector FOV that overlaps at least a first illuminator FOV of the plurality of N illuminator FOVs; and
at least one processor configured to:
cause a first illuminator of the plurality of N illuminators to emit an optical pulse to illuminate the first illuminator FOV,
obtain a signal representing at least one reflected optical pulse detected by the detector, and
determine a position of at least one target using the signal.

28. The hybrid LiDAR system recited in claim 27, wherein the detector FOV is a first detector FOV, and wherein the detector is further configured to observe a second detector FOV that overlaps at least a second illuminator FOV of the plurality of N illuminator FOVs.

29. The hybrid LiDAR system recited in claim 27, wherein the detector FOV overlaps a second illuminator FOV of the plurality of N illuminator FOVs.

30. The hybrid LiDAR system recited in claim 27, wherein the at least one detector array comprises a plurality of detector arrays, and wherein a particular focusing component of the at least one focusing component is configured to focus reflected signals on the plurality of detector arrays.

31. The hybrid LiDAR system recited in claim 30, wherein the particular focusing component comprises a lens and/or a mirror and each of the plurality of N illuminators comprises a respective laser.

32. (canceled)

33. The hybrid LiDAR system recited in claim 27, wherein the at least one focusing component comprises a plurality of focusing components, and the at least one detector array comprises a plurality of detector arrays.

34. The hybrid LiDAR system recited in claim 33, wherein the plurality of focusing components comprises N focusing components and the plurality of detector arrays comprises N detector arrays.

35. The hybrid LiDAR system recited in claim 34, wherein each of the plurality of N illuminators is associated with a respective one of the N focusing components and a respective one of the N detector arrays.

36. The hybrid LiDAR system recited in claim 35, wherein each of the N detector arrays comprises at least 200 optical detectors, wherein each of the at least 200 optical detectors comprises an avalanche photodiode (APD), a single-photon avalanche diode (SPAD), or a silicon photomultiplier (SiPM).

37. (canceled)

38. The hybrid LiDAR system recited in claim 27, wherein the at least one detector array comprises a plurality of avalanche photodiodes, single-photon avalanche diode (SPAD) detectors, or silicon photomultiplier (SiPM) detectors.

39. The hybrid LiDAR system recited in claim 27, wherein each of the plurality of N illuminators comprises a respective laser.

40. The hybrid LiDAR system recited in claim 39, wherein the at least one focusing component comprises a lens.

41. The hybrid LiDAR system recited in claim 40, wherein the at least one detector array includes a plurality of detector arrays, and wherein the lens is shared by the plurality of detector arrays.

42. (canceled)

43. The hybrid LiDAR system recited in claim 27, wherein the at least one focusing component comprises a mirror.

44. (canceled)

45. The hybrid LiDAR system recited in claim 27, wherein the plurality of N illuminators includes at least 40 illuminators and/or the at least one detector array comprises at least 200 optical detectors.

46. (canceled)

47. The hybrid LiDAR system recited in claim 27, wherein the detector FOV is a first detector FOV and the optical pulse is a first optical pulse, and wherein the detector is further configured to observe a second detector FOV that overlaps a second illuminator FOV of the plurality of N illuminator FOVs, and wherein the at least one processor is further configured to cause a second illuminator of the plurality of N illuminators to emit a second optical pulse to illuminate the second illuminator FOV.

48. A vehicle comprising a hybrid LiDAR system, the hybrid LiDAR system comprising:
a long-range LiDAR subsystem characterized by a first range and a first azimuth angular coverage; and
a short-range LiDAR subsystem characterized by a second range and a second azimuth angular coverage,
wherein:
the first range is greater than the second range, and
the second azimuth angular coverage is greater than the first azimuth angular coverage.

49. The vehicle recited in claim 48, wherein:
the long-range LiDAR subsystem comprises a first portion situated to sense a first volume of space in front of the vehicle and a second portion situated to sense a second volume of space behind the vehicle, and
the short-range LiDAR subsystem is situated to sense a third volume of space in front of the vehicle.

50. The vehicle recited in claim 49, wherein:
the first volume of space and the third volume of space partially overlap, or
the first volume of space and the third volume of space are non-intersecting.

51. (canceled)

52. The vehicle recited in claim 49, wherein the long-range LiDAR subsystem is further characterized by a first elevation angular coverage, and the short-range LiDAR subsystem is further characterized by a second elevation angular coverage, wherein the second elevation angular coverage is larger than the first elevation angular coverage.

53-55. (canceled)
